(19) United States
(12) Patent Application Publication
(10) Pub. No.: US 2009/0165708 A1
(43) Pub. Date: Jul. 2, 2009

(54) Spherical Striping Apparatus

(76) Inventor: William Shoemaker, (US)

Correspondence Address: William Shoemaker, 580 County Highway 20, Edmeston, NY, 13335, US

(21) Appl. No.: 11/968,641

(22) Filed: Jan. 2, 2008

(51) Int. Cl. B05C 1/00; B44D 3/22

(52) U.S. Cl. 118/232

(57) ABSTRACT

My invention relates to a method and apparatus for painting a stripe on the outside surface of spherical objects such as golf balls with their axes horizontal and rotating during the painting operation, the stripe is being painted circularly around the sphere with the axis as the center. The sphere being striped is supported for free rotation about its horizontal axis by bushing cups that are mounted on rotating shafts with a spring to apply pressure inward holding sphere in place. A felt tip paint marker or refillable ink marker, that is in contact with the sphere or golf ball, applies a stripe to outside surface so it may be identified as a range ball.

### BACKGROUND OF THE INVENTION

This invention relates generally to apparatus useful for applying a stripe to the outside surface of sphere such as golf ball so it can be identified as a range ball. A range ball is striped to distinguish it from other balls on a golf course. Range balls are the property of golf course and not to be used in a round of golf on the course.

Prior devices for striping a spherical object require placing each individual sphere in position then rotating the ball by means of hand crank or motor and applying a stripe with paint brush. To place sphere in some devices it would have to be pulled apart with one hand while placing the sphere (or ball) in position with other hand.

Prior devices are slow and messy.

### BRIEF SUMMARY OF INVENTION

Apparatus for applying a stripe to the outside surface of a spherical object such as golf ball, which comprises frame, bushing cups that are mounted on shafts for rotation of sphere on horizontal axis, holder for felt tip paint marker or refillable ink marker that applies stripe, gears for transmitting power, a cam that opens and closes bushing cups, automatic feed assembly and electric motor. Golf balls are placed in channel of automatic feed that is sloped so that balls roll toward machine. The golf ball sitting on push block just below channel that is the next ball to be striped holds the golf balls in the channel back. After the golf ball in machine has been striped the bushing cup that is operated by a cam opens up allowing the striped ball to drop and roll away. The cam holds the bushing cup open until the ball on push block is raised into position. As the push block is raising the next ball to be striped it holds back the balls in channel until the top edge of push block drops below the bottom edge of channel allowing the next ball to drop into place.

### BRIEF DESCRIPTION OF DRAWINGS

This invention relates to apparatus for applying a pigment stripe to outside surface of spherical object such as golf ball.

FIG. 1 is an isometric view of the apparatus as seen by the operator

FIG. 2 is an isometric view of apparatus to describe parts not visible in FIG. 1

FIG. 3 is an isometric view of front and opposite side of FIG. 1 to describe parts not visible in FIG. 1 and FIG. 2

FIG. 4 is an isometric view of side frames 21 with cam 34 removed to describe parts not visible with cam 34 in place.

FIG. 5 is an isometric view of side frame 21 with cam 34 in place to describe cam 34 operation.

FIG. 6 is an isometric view of frame 21 to describe parts not visible in FIG. 4 and FIG. 5

FIG. 7 is an isometric view of automatic ball feed.

FIG. 8 is a side view of automatic ball feed to describe parts not visible in FIG. 7.

FIG. 9 is isometric view of automatic ball feed parts.

FIG. 10 is an isometric view of cam 34 and gear 24.

FIG. 11 is an isometric view of wedge block 27.

FIG. 12 is an isometric view of felt tip paint marker 6 and marker holder 7.

FIG. 13 is an isometric view of gears 22, 25 and 37.

FIG. 14 is an isometric view of gears 24,26 and 38.

FIG. 15 is an isometric view of gear 23.

FIG. 16 is an isometric view of bushing cups that support ball in striping operation.

### DETAILED DESCRIPTION

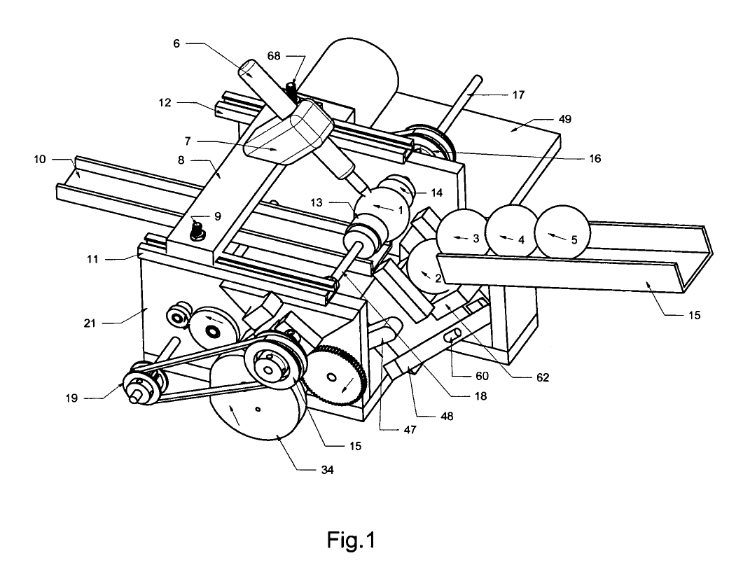

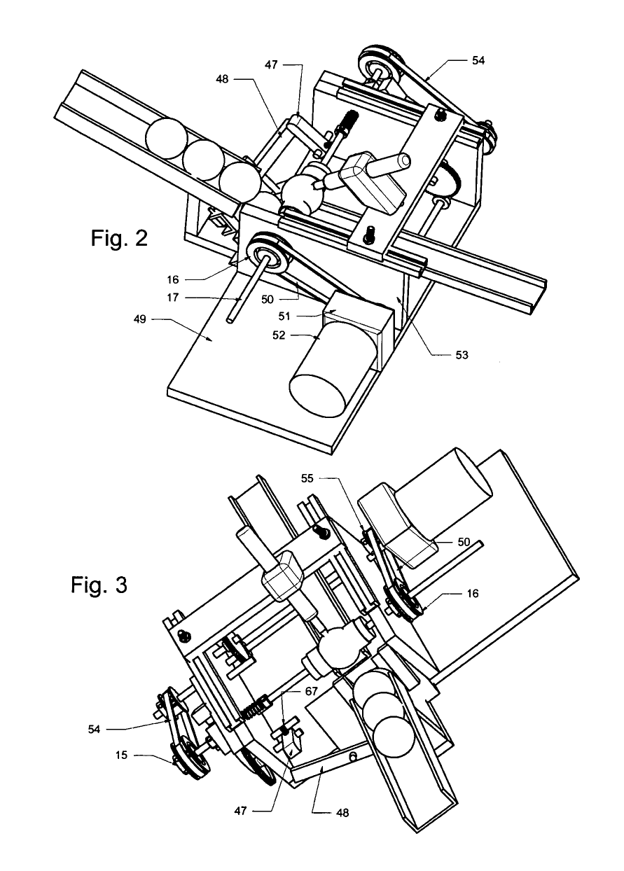

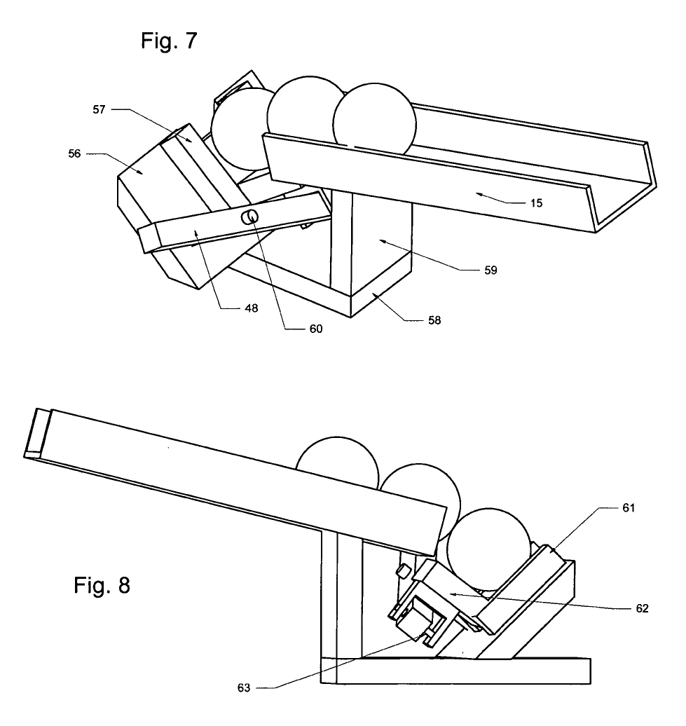

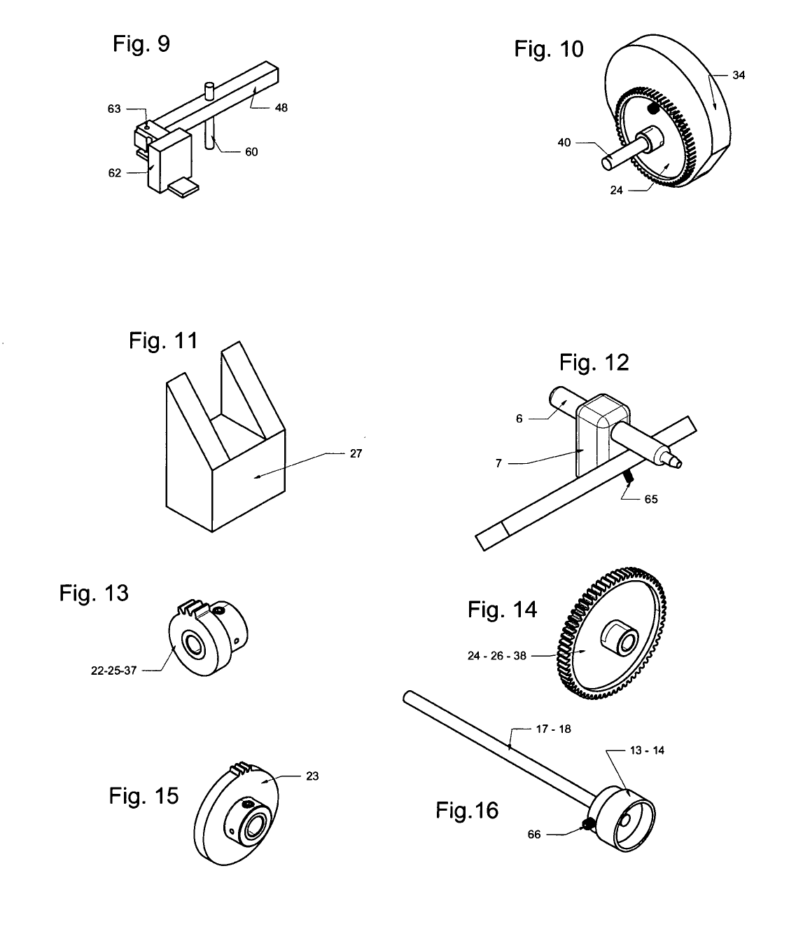

FIG. 1 is an isometric view of apparatus as seen by operator. Golf balls 1-2-3-4-5 or spherical objects are placed in channel 15 of automatic ball feed supported by frame piece 59 that is attached to frame piece 58 by suitable means such screws. Frame pieces 56-58 are attached to frame base by suitable means such screws. (FIG. 7 and FIG. 8). Channel 15 is sloped toward apparatus. Slope shown in FIG. 8. Golf ball 1 will drop to push block 62 that centering blocks 57-61 (shown in FIG. 7 and FIG. 8) hold in place on frame piece 56. Push block 62 moves ball 1 upward towards bushing cups 13-14 that clamp golf ball 1 into position to be striped, push block 62 holds back golf balls 2-3-4-5 until top edge of push block 62 drops below bottom edge of channel 15 then golf ball 2 drops into place and process is repeated. When cam 47 engages lever 48 that rotates on pin 60 shown in FIG. 9 push block 62 that is attached to lever 48 by pin 63 that allows push block 62 to rotate, is moved upward to bushing cups 13-14.

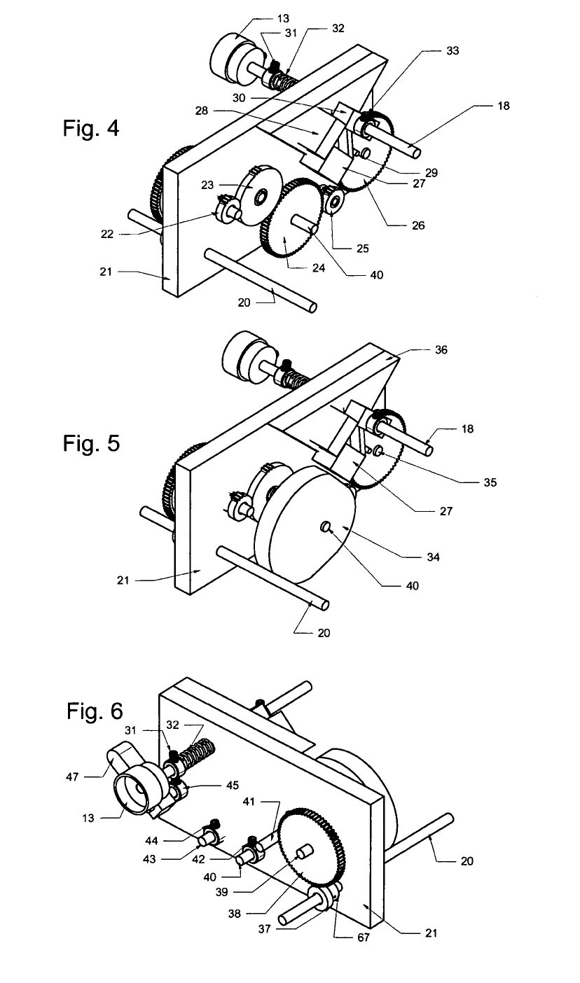

Cam 47 maintains its rotation from shaft 35 that is attached to gear 26 by press fit. Shaft 35 is supported by side frame 21. Shaft 35 is held in place by shaft collar 45. Gear 26 maintains its rotation from gear 25 that is attached to shaft 43 by press fit. Shaft 43 is supported by side frame 21 and held in place by shaft collar 44. Gear 25 maintains its rotation from gear 24 that is attached to shaft 40 by press fit that is supported by side frame 21. Shaft 40 is held in position by shaft collar 42. Gear 24 also maintains rotation of cam 34 (shown in FIG. 1 and FIG. 5) that actuates wedge 27 (held in place by block 28 and pin 29 FIG. 4) that pushes in-between frame spacer 36 and wedge block 30 (that is held in position by shaft collar 33) that moves shaft 18 that is supported by side frame 21 outward contracting spring 32 (held in position by shaft collar 31) relieving clamping pressure of bushing cup 13 that allows striped ball to drop to channel 10 and roll away. Cam 34 is attached to gear 24 by screw 64 shown FIG. 10. Gear 24 maintains its rotation from gear 23 that is attached to shaft 41 by press fit that is supported by side frame 21 and held in place by shaft collar (not shown). Gear 23 maintains its rotation from gear 22 that is attached to shaft 39 by press fit. Shaft 39 is supported by side frame 21. Shaft 39 maintains its rotation from gear 38 (FIG. 6) that is attached to shaft 39 by press fit. Gear 38 maintains its rotation from gear 37 that is attached to shaft 20 by press fit and roll pin 67 through center hub on gear 37 and shaft 20. Shaft 20 maintains its rotation from gearbox 51 that is powered by motor 52 that is attached to frame base 49 by suitable means such as screws. Shaft 20 that is supported by side frames 21-53 also rotates pulleys 19-55 attached by suitable means such as setscrews. Pulleys 19-55 drive belts 50-54 that maintain rotation of pulleys 15-16 (attached to shafts by suitable means such as set screws) that maintain the rotation of shafts 17-18 (shaft 17 is supported by side frame 53 and shaft 18 is supported by side frame 21) that maintain the rotation of bushing cups 13-14 that hold sphere or golf ball during striping operation.

The stripe is applied by a felt tip paint marker 6 that is in contact with the outside surface of golf ball or sphere. The felt tip marker is supplied by outside source such as sharpie, uni paint, nissen or a refillable felt tip marker, any brand will work. The felt tip marker 6 is held in position by marker holder 7 that is attached to adjustable plate 8 shown FIG. 12 by suitable means such as screw 65. Adjustable plate slides in slot tracks 11-12 and is adjusted by screws 9 and 68.

Bushing cups 13-14 are attached to shafts 17-18 by a suitable means such as screw 66 shown in FIG. 16. Loosening screw 67 FIG. 3 and rotating cam 47 on shaft 35 will achieve correct timing of ball delivery to bushing cups 13-14.

Bearings or bushing may or may not be used to support shafts 17-18-20-35-39-41-40-43 in side frames 21-53 depending on material of choice for constriction of apparatus, for example polyethylene has exceptionally high abrasion resistance properties.

What is claimed is:

1. An apparatus and method of applying a stripe to the outside surface of a spherical object such as a golf ball, by rotating spherical object on its horizontal axis applying stripe circularly about the center of sphere. Said apparatus comprising: a frame to support rotating shafts, bushing cups rotating on horizontal axis that hold sphere in place when stripe is applied, a cam that opens and closes bushing cups for capture and release of sphere during striping process, automatic feed for delivery of spheres to bushing cups, a cam that operates automatic feed, a channel that allows striped spheres to roll away after striping process is complete, adjustable felt tip marker holder that holds a felt tip marker or paint marker in place to apply stripe,

2. The apparatus of claim 1 is powered by an electric motor with gearbox that maintains rotation of, shafts, pulleys, gears and belts.
